(19) United States
(12) Patent Application Publication
(10) Pub. No.: US 2010/0282684 A1
(43) Pub. Date: Nov. 11, 2010

(54) LIPOPOLYSACCHARIDE DECONTAMINATION

(76) Inventors: Paolo Costantino, Siena (IT); Gianluca Ciardelli, Pisa (IT); Niccoletta Barbani, Pisa (IT)

Correspondence Address: NOVARTIS VACCINES AND DIAGNOSTICS INC., INTELLECTUAL PROPERTY- X100B, P.O. BOX 8097, Emeryville, CA, 94662-8097, US

(21) Appl. No.: 12/744,306

(22) PCT Filed: Jan. 7, 2009
(86) PCT No.: PCT/IB2009/000133

§ 371 Date: Jul. 16, 2010

(30) Foreign Application Priority Data
Jan. 7, 2008 (GB) 0800228.9

(51) Int. Cl. B01D 15/04; C08F 118/02

(52) U.S. Cl. 210/691; 210/690; 526/319

(57) ABSTRACT

Materials and methods for the selective removal of lipopolysaccharide during the purification of molecules of bio-pharmaceutical interest are based on a polymeric substrate that binds lipopolysaccharide. Preferably, the polymeric substrate is selective for at least one of heptose and 2-keto-3-deoxyoctonic acid. The substrate can be formed by a process comprising: (i) contacting a homogeneous polymer solution and a template solution; (ii) carrying out a phase inversion of the resulting solution; and (iii) removing the template.

This application claims priority from United Kingdom patent application 0800228.9, filed on 7 Jan. 2008, the full contents of which are incorporated by reference herein.

### TECHNICAL FIELD

This invention is in the field of lipopolysaccharide decontamination.

### BACKGROUND

Lipopolysaccharide is released when Gram-negative bacteria, such as Escherichia coli and Salmonella enterica, multiply or are lysed. It functions as a powerful bacterial toxin, known as endotoxin, and is responsible for many of the toxic and immunogenic effects associated with infections with Gram-negative bacteria. Endotoxin is a frequent contaminant in plasmid DNA prepared from bacteria and must therefore be removed prior to any in vivo applications in order to prevent any undesirable inflammatory responses. Similarly, it is desirable to purify other biomolecules prepared from Gram-negative bacteria (e.g. capsular polysaccharides of Gram-negative bacteria or Escherichia coli derived recombinant proteins), and also pharmaceutical water, from residual endotoxin.

The ability to selectively remove lipopolysaccharide, or endotoxin, during the purification of molecules of biopharmaceutical interest is therefore desirable.

### DISCLOSURE OF THE INVENTION

The present invention provides materials and methods for the selective removal of lipopolysaccharide during the purification of molecules of biopharmaceutical interest.

Accordingly, the invention provides a membrane for adsorption of lipopolysaccharide, comprising a polymeric substrate that binds lipopolysaccharide. Preferably, the polymeric substrate is selective for at least one of heptose and 2-keto-3-deoxyoctonic acid.

The invention also provides a process for forming a polymeric substrate that binds lipopolysaccharide, comprising the steps of:
i. contacting a homogeneous polymer solution and a template solution;
ii. carrying out a phase inversion of the resulting solution; and
iii. removing the template.

The invention further provides another process for forming a polymeric substrate that binds lipopolysaccharide, comprising the steps of:
i. contacting a monomer solution and a template solution;
ii. reacting cross-linking groups of the monomers to form a polymer; and
iii. removing the template.

Preferably, each process further comprises the step of making a membrane.

In addition, the invention provides a method for the removal of lipopolysaccharide from a suspension, comprising the steps of
i. providing a polymeric substrate that binds lipopolysaccharide; and
ii. contacting the suspension with the polymeric substrate.

### BRIEF DESCRIPTION OF DRAWINGS

FIG. 1 shows the % recovery of endotoxin after filtration with Kdo-imprinted and non-imprinted membranes. Squares are for MIM; triangles, are for NMIM. X-axis is filtrate volume (ml).

FIG. 2 shows the % recovery of endotoxin after filtration with re-used Kdo-imprinted and non-imprinted membranes. Filled bars are MIM, empty bars are NMIM. X-axis is filtrate vol (ml).

### DETAILED DESCRIPTION OF THE INVENTION

Gram-negative Bacteria

The present invention is concerned with lipopolysaccharide derived from Gram-negative bacteria. Many species of these bacteria are pathogenic, this characteristic being particularly associated with the lipopolysaccharide layer of the bacterial cell. Gram-negative bacteria include, but are not limited to: proteobacteria, including Escherichia, Salmonella, and other Enterobacteriaceae, Pseudomonas, Moraxella, Helicobacter, Stenotrophomonas, Bdellovibrio, Yersinia, acetic acid bacteria and Legionella; cyanobacteria; spirochaetes; green sulfur; and green non-sulfur bacteria. Gram-negative cocci include Neisseria gonorrhoeae, Neisseria meningitidis and Moraxella catarrhalis. Gram-negative bacilli include Hemophilus influenzae, Klebsiella pneumoniae, Legionella pneumophila, Pseudomonas aeruginosa, Escherichia coli, Proteus mirabilis, Enterobacter cloacae, Serratia marcescens, Helicobacter pylori, Salmonella enteritidis, and Salmonella typhi. Nosocomial Gram-negative bacteria include Acinetobacter baumanii.

Lipopolysaccharide

The outermost layer of the membrane of Gram-negative bacteria consists predominantly of lipopolysaccharides, all of which, irrespective of the bacteria from which they are derived, have a common basic structure, consisting of a lipid component, termed lipid A, and a hydrophilic heteropolysaccharide. Lipid A provides the anchor that secures the molecule within the membrane, whilst the polysaccharide component projects from the surface and interacts with the external environment.

The heteropolysaccharide unit of lipopolysaccharide comprises two parts: a core oligosaccharide, and an outer O-specific polysaccharide side chain comprising a complex polymer of oligosaccharides, which determines the antigenic specificity of the lipopolysaccharide and is often termed an O-antigen. This component is peculiar to the particular bacteria that have synthesised it; different bacteria synthesise lipopolysaccharide molecules that differ in the length and fine structure of the O-specific polysaccharide side chains. The inner part of the core comprises the characteristic and unusual components heptose (in the L-glycero-D-manno configuration) and 2-keto-3-deoxyoctonic (or 3-deoxy-D-manno-oct-2-ulosonic) acid (Kdo).

As used herein, the term “heptose” will be understood to refer to “L-glycero-D-manno-heptose” and the term “2-keto-3-deoxyoctonic acid” will be understood to refer to “3-deoxy-D-manno-oct-2-ulosonic acid.”

Preferably, the polymeric substrate that forms the membrane of the present invention is selective for at least one of heptose and 2-keto-3-deoxyoctonic acid. As discussed above, these unusual sugars are characteristic of lipopolysaccharide. A polymeric substrate capable of recognising and selectively binding these moieties can remove lipopolysaccharide from a suspension.

Adsorption of Lipopolysaccharide

The present invention provides a membrane for adsorption of lipopolysaccharide, comprising a polymeric substrate that binds lipopolysaccharide. In the present context, a “membrane” is a thin sheet of material that is permeable to certain substances in solution or suspension. The membrane of the present invention is a continuous medium formed from a polymeric substrate or matrix and may be formed as a planar, concave or convex sheet, or may take any other suitable shape. Those molecules that are prevented from traversing the membrane are discriminated by their physical or chemical properties. The method of the present invention, for the removal of lipopolysaccharide from a suspension, may employ different arrangements of the polymeric substrate, such as discrete particles or microspheres in suspension. Alternatively, the polymeric substrate may be bound to a solid-state support, such as beads, plates, columns, filters or porous solids.

Adsorption may take place by either or both of physisorption and chemisorption. Those molecules that are adsorbed onto the polymeric substrate are removed from the suspension that is being processed. Following the processing of the suspension, the molecules that are adsorbed onto the polymeric substrate may be removed by methods known in the art to allow the polymeric substrate to be re-used.

The polymeric substrate can be formed from a combination of any suitable monomers, polymers and copolymers that are known in the art. Preferably, the polymeric substrate is formed by molecular imprinting technology. This technique produces polymeric substrates that are capable of molecular recognition. The polymeric matrix is able to differentiate between chemical species and bind those that exhibit certain functional groups, thus giving a high level of selectivity.

Another aspect of the present invention provides a process for the formation of the molecularly imprinted polymeric substrates by the polymerisation of a set of functional monomers in the presence of a template. The functional monomers may comprise a functional head group, capable of forming a binding interaction with the template, and a cross-linking group, capable of covalently bonding to other monomers. The polymerisation step may involve chain-growth polymerisation or step-growth polymerisation and may be initiated by any means known in the art. A further aspect of the present invention provides a process for the formation of the molecularly imprinted polymeric substrates by phase inversion of a homogeneous polymer solution containing a template.

The subsequent extraction of the template leaves behind a cavity in the polymeric substrate that is complementary in size, shape and functionality to the template. This cavity is capable of binding either the template in isolation or molecules that incorporate the functionality of the template (i.e. include the same specific arrangement of functional groups) within their structure. Thus, in the present invention, heptose and/or 2-keto-3-deoxyoctonic acid or small oligosaccharides containing their chemical structure can be used as templates for the manufacture of polymeric substrates that selectively bind lipopolysaccharide. The process for forming a polymeric substrate involves the use of a template solution that preferably comprises at least one of heptose and 2-keto-3-deoxyoctonic acid in order to give the polymeric substrate the required selectivity. These molecularly imprinted polymeric substrates may then be made into the porous membranes, for bio-separation, of the present invention.

In a preferred embodiment, the polymeric substrate is obtained by phase inversion.

The polymeric substrate may comprise one or more polar groups. For example, the polymeric substrate may comprise one or more amine, hydroxyl or sulphydryl groups, particularly hydroxyl groups. The inventors have found that a polymeric substrate comprising hydroxyl groups is capable of binding lipopolysaccharide. For example, the polymeric substrate may comprise poly(ethylene-co-vinyl alcohol), a copolymer that may be employed in the method of forming a molecularly imprinted polymeric substrate by phase inversion. The properties of this copolymer, sold under the name EVAL™, are determined by control of the polymerisation ratio of the constituent monomers, ethylene and vinyl alcohol, and of the degree of polymerisation that is reached during the polymerisation reaction. The resulting random, crystalline polymer is represented by the following molecular formula:

—(CH₂—CH₂)ₘ—(CH₂—CHOH)ₙ—

where m and n are integers. Any suitable ratio of ethylene:co-vinyl alcohol may be used. In particular, a ratio of 30-60:70-40 may be used, particularly a ratio of 40-50:60-50. For example, ratios of 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51, 50:50, 51:49, 52:48, 53:47, 54:46, 55:45, 56:44, 57:43, 58:42, 59:41 or 60:40 may be used, particularly ratios of 40:60, 41:59, 42:58, 43:57, 44:56, 45:55, 46:54, 47:53, 48:52, 49:51 or 50:50. The inventors have found that a ratio of 44:56 is suitable for binding lipopolysaccharide.

Another aspect of the invention provides a method for the removal of lipopolysaccharide from a suspension that involves contacting the suspension with the polymeric substrate that binds lipopolysaccharide as described above. The polymeric substrate may be in the form of a membrane or discrete particles or may be attached to a solid state support. Preferably, the suspension comprises water, e.g. in the form of a biological fluid. More preferably, the suspension comprises a pharmaceutical ingredient. Even more preferably, the pharmaceutical ingredient is a bacterial vaccine. Other materials from which LPS may be removed are the materials used in the preparation and/or formulation of a finished dosage form containing the pharmaceutical ingredient.

General

The term “comprising” encompasses “including” as well as “consisting” e.g. a composition “comprising” X may consist exclusively of X or may include something additional e.g. X+Y.

The term “suspension” encompasses solutions and any colloidal dispersion, wherein a species may either remain suspended in a solvent or may become solvated to form a homogeneous mixture.

The term “pharmaceutical ingredient” refers to drugs intended for human or veterinary use.

The method of the invention can be used for preparative and/or analytical purposes. References to “preparation”, etc. should not be construed as excluding analytical methods.

The term “bacterial vaccine” refers to a suspension of bacteria, attenuated or killed bacteria, or their antigenic derivatives that may be administered to induce an immune response for the prevention or treatment of bacterial disease.

The term “oligosaccharide” refers to a saccharide polymer containing a small number (typically three to twenty) of component sugars.

A “solid-state support” is something that is insoluble in a particular solvent system (e.g. water or an organic solvent). It may be comprised of glass, ceramics, metals, plastics, woods, or any other material upon which a polymeric substrate may be bound.

It will be appreciated that the ionisable groups of the compounds described herein may be present in the neutral form or in the charged form e.g. depending on pH. For example, a carboxyl —COOH may be deprotonated to give the anionic —COO⁻ group. Salts of any charged molecules may also be employed in the present invention.

### MODES FOR CARRYING OUT THE INVENTION

Preparation, Characterization and Testing of Molecular Imprinted Membranes for LPS Capture

Introduction

A membrane for specific recognition of Kdo was prepared using molecular imprinting technology. The membranes were formed using a phase inversion procedure. The polymer solution used in the manufacture of the membrane was EVAL™ (poly(ethylene-co-vinyl alcohol)), with a ethylene:co-vinyl alcohol ratio of 44:56. The template solution comprised Kdo.

Membrane Preparations

NMIM—Non-imprinted (control) membrane (prepared without template). A 15% suspension of EVAL™ in DMSO was heated under stirring at 100° C. until a homogeneous solution was obtained. 2 to 3.5 ml of this solution was then poured onto a 8.5×14 cm² glass support and a 400 μm thick homogeneous layer obtained by cutting with a knife. The layer was coagulated with 400 ml of a first coagulation (inversion) bath composed of H₂O/DMSO (50/50 v/v) for an hour. The membrane was then placed in 400 ml of H₂O for six hours. At the end of this inversion procedure, the membrane was dried by freeze-drying. The resultant membrane had a thickness of 200 μm.

MIM—Imprinted (test) membrane (prepared with template). This membrane was prepared using the same procedure as above except that the starting suspension was 3 ml of 15% suspension of EVAL™ in DMSO containing 50 mg of Kdo. After membrane preparation, residual template was removed by extensively flushing the membrane with water using a re-circulation system operating at a pressure of 0.2 bar.

Testing Membrane Capacity for Kdo

To determine the binding capacity of the MINI for Kdo, 100 ml of 10 μg/ml Kdo solution in water was re-circulated overnight through the MIM assembled on a filtration device. The difference between the Kdo concentration in the re-circulating solution at time 0 and the end of the re-circulation was used to calculate a binding capacity for Kdo based on the total volume of the solution and the weight of membrane used during the re-circulation. A value of about 8 μg/mg membrane was observed. In a similar experiment, the NMIM had no significant binding capacity for Kdo. To test the selectively of the MIM membrane for Kdo, a similar experiment was carried out wherein the Kdo was replaced with sialic acid. No significant binding capacity for sialic acid was observed (1 μg/mg membrane). Sialic acid and Kdo concentrations were determined using the procedure of Osborn (1963) PNAS, 50:499-506.

LPS binding Experiments

A section of MIM membrane was cut and fitted to a filtration holder to provide a filtration surface area of 4.9 cm². A syringe was then used to flush the system with pyrogen-free distilled water, followed by 0.1 M NaOH and again with distilled water until the permeate was at neutral pH.

10 ml of standard E. coli lipopolysaccharide (LPS) solution at a concentration of 50 UI/ml (total 500 UI) was passed through the membrane using the syringe. Four fractions of 2.5 ml were collected and a 0.7 ml sample taken from each fraction for Limulus Amoebocyte Lysate (LAL) analysis of endotoxin concentration. The fractions were then pooled together (Pool 1) and a 0.7 ml sample of the pooled, total permeate taken for analysis. 6 ml of the pooled permeate were passed once again through the membrane. This time, four fractions of 1.5 ml were collected and a 0.7 ml sample taken from each fraction for analysis. These fractions were then pooled together (Pool 2) and a further 0.7 ml sample taken for analysis.

After use, the membrane was flushed with distilled water, 0.1 M NaOH and distilled water again until the permeate was at neutral pH.

The endotoxin concentration of the starting material loaded onto the filter (SM) and other samples was analysed (Table 1).

TABLE 1
Kdo binding experiment with imprinted membrane (MIM)

| Sample | Vol (ml) | UI/ml | Tot UI | Recovery % |
|---|---|---|---|---|
| SM loaded | 10 | 41.8 | 418 | 100 |
| Wash Filter | | <0.05 | | |
| Fraction 1/1 | 2.5 | 5.22 | 13.05 | 3.1 |
| Fraction 2/1 | 2.5 | 9.37 | 23.425 | 5.6 |
| Fraction 3/1 | 2.5 | 9.39 | 23.475 | 5.6 |
| Fraction 4/1 | 2.5 | 8.53 | 21.325 | 5.1 |
| Sum UI fractions | | | 81.27 | 19.4 |
| 1 to 4 | | | | |
| Pool 1 | 10 | 4.91 | 49.1 | 11.7 |
| Pool 1 | 6 | 4.91 | 29.46 | |
| Fraction 1/2 | 1.5 | 4.63 | 6.945 | 23.6 |
| Fraction 2/2 | 1.5 | 5.99 | 8.985 | 30.5 |
| Fraction 3/2 | 1.5 | 5.64 | 8.46 | 28.7 |
| Fraction 4/2 | 1.5 | 5.49 | 8.235 | 27.9 |
| Sum UI fractions | | | 32.625 | 110.74 |
| 1 to 4 | | | | |
| Pool 2 | 6 | 5.25 | 31.5 | 106.9 |

An experiment using the same conditions was carried out with the NMIM membrane (Table 2).

TABLE 2
Kdo binding experiment with non-imprinted membrane (NMIM)

| Sample | Vol (ml) | UI/ml | UI tot | Recovery (%) |
|---|---|---|---|---|
| WFI | | <0.05 | | |
| SM | 10 | 50 | 500 | 100 |
| Wash filter | | 43.1 | 64.2 | |
| Fraction 1/1 | 2.5 | 90.4 | 226 | 45.2 |
| Fraction 2/1 | 2.5 | 69.5 | 173.75 | 34.75 |
| Fraction 3/1 | 2.5 | 62.2 | 155.5 | 31.1 |
| Fraction 4/1 | 2.5 | 34.1 | 85.25 | 17.05 |
| Sum UI fractions 1 | | | 640.5 | 128.1 |
| to 4 | | | | |
| Pool 1 | 10 | 57.4 | 574 | 114.8 |
| Strip | | 54.9 | 109.8 | 21.8 |

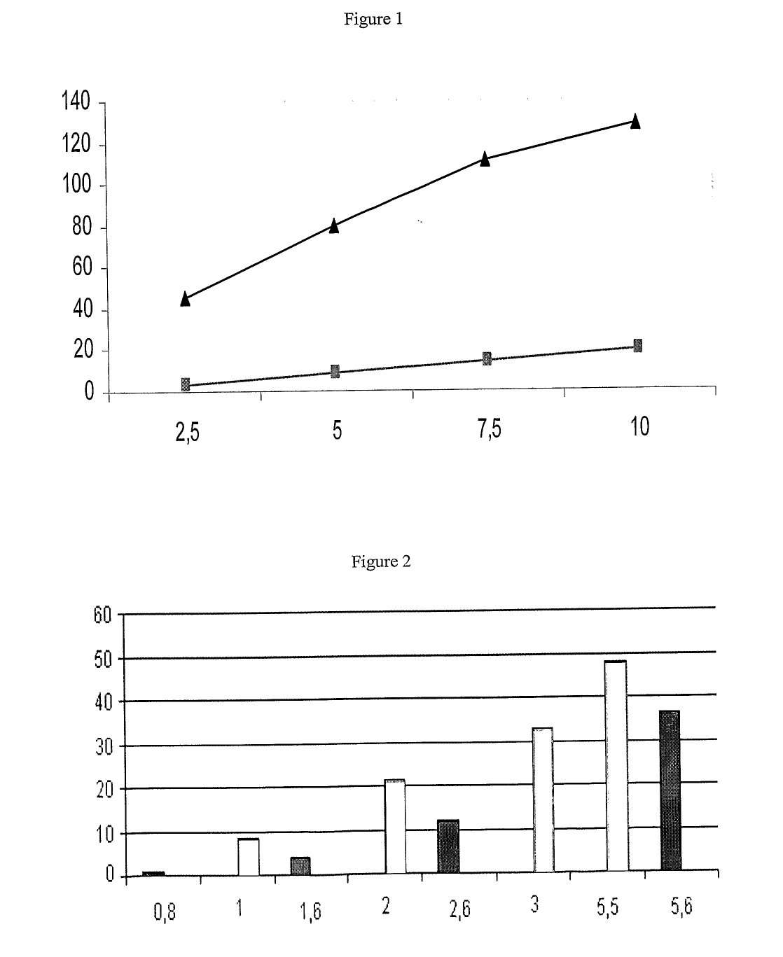

The results of these two experiments are summarised in FIG. 1. The two experiments were repeated using the same (i.e. used) MIM and NMIM membranes (Table 3, FIG. 2).

TABLE 3
Binding experiment with used MIM and NMIM membranes

| | Vol (ml) | UI/ml | Tot UI | Recovery % |
|---|---|---|---|---|
| Samples MIM | | | | |
| rinse Holder | 20 | 0.05 | 1 | |
| Wash Filter | 20 | 0.154 | 3.08 | |
| SM loaded | 5.5 | 45 | 247.5 | 100 |
| Fraction 1/1 | 0.8 | 3.25 | 2.6 | 1.1 |
| Fraction 2/1 | 0.8 | 8.91 | 7.128 | 2.9 |
| Fraction 3/1 | 1 | 20 | 20 | 8.1 |
| Fraction 4/1 | 3 | 19.9 | 59.7 | 24.1 |
| Strip 1 | 11 | 1.15 | 12.65 | 5.1 |
| Strip 2 | 11 | 0.303 | 3.333 | 1.3 |
| Total eluted | | | 105.411 | 42.6 |
| Samples NMIM | | | | |
| Wash Filter | 20 | <0.5 | | |
| rinse Holder | 20 | <0.5 | | |
| SM loaded | 6 | 45 | 270 | 100 |
| Fraction 1/2 | 1 | 22.6 | 22.6 | 8.37 |
| Fraction 2/2 | 1 | 35.1 | 35.1 | 13.00 |
| Fraction 3/2 | 1 | 31.6 | 31.6 | 11.70 |
| Fraction 4/2 | 2.5 | 16.1 | 40.25 | 14.91 |
| Strip 1 | 11 | 0.134 | 1.474 | 0.55 |
| Strip 2 | 13 | <0.5 | | 0.00 |
| Total eluted | | | 131.024 | 48.53 |

Discussion

Membranes capable of selectively binding Kdo, a conserved component of LPS, have been prepared.

The fresh imprinted membrane (MIM) showed a potential capacity to bind LPS of about 80% of the initial load. The control membrane (NMIM) did not show any significant binding of LPS (compare Tables 1 and 2, FIG. 1). The MIM filtrate contained about 12% of the initial LPS load (Table 1, Pool 1). However, after the membrane was flushed with distilled water and re-loaded with LPS, no further LPS binding was observed (Table 1, Pool 2). This suggests that the membrane may have been saturated with LPS.

When the membranes were re-used, a different behaviour was observed (Table 3). Both membranes seemed to retain approximately 50-60% of the initial LPS load. However, an analysis of the cumulative recovery of LPS suggests that the imprinted membrane still demonstrated a greater binding of LPS, at least at the beginning of the filtration process (FIG. 2). The results observed with re-used membranes suggest that re-utilization of the membranes is not preferred. Without wishing to be bound by theory, it is possible that structural modifications take place following the first use of the membranes that confer different properties and perhaps a specific binding. Alternatively/additionally, it is possible that the washing procedure carried out on the MIM membrane prior to re-use was not sufficient to remove all of the bound LPS, meaning that not all of the initial Kdo binding sites were available.

These results confirm that it is possible to manufacture filtration membranes that recognize and bind LPS from aqueous solutions using the principle of molecular imprinting technology.

It will be understood that the invention has been described by way of example only and modifications may be made whilst remaining within the scope and spirit of the invention.

1. A membrane for adsorption of lipopolysaccharide, comprising a polymeric substrate that binds lipopolysaccharide.

2. The membrane of claim 1, wherein the polymeric substrate is selective for at least one of heptose and 2-keto-3-deoxyoctonic acid.

3. The membrane of either of claims 1 and 2, wherein the lipopolysaccharide is from Gram-negative bacteria.

4. The membrane of claim 3, wherein the Gram-negative bacteria are proteobacteria, cyanobacteria, spirochaetes, green sulphur bacteria, green non-sulphur bacteria, crenarchaeota, cocci, bacilli or nosocomial bacteria.

5. A process for forming a polymeric substrate that binds lipopolysaccharide, comprising steps of:
i. contacting a homogeneous polymer solution and a template solution;
ii. carrying out a phase inversion of the resulting solution; and
iii. removing the template.

6. A process for forming a polymeric substrate that binds lipopolysaccharide, comprising steps of:
i. contacting a monomer solution and a template solution;
ii. reacting cross-linking groups of the monomers to form a polymer; and
iii. removing the template.

7. The process of either of claims 5 and 6, further comprising the step of making a membrane.

8. The process of claim 5 or claim 6, wherein the template solution comprises at least one of heptose and 2-keto-3-deoxyoctonic acid.

9. A method for the removal of lipopolysaccharide from a suspension comprising steps of:
i. providing a polymeric substrate that binds lipopolysaccharide; and
ii. contacting the suspension with the polymeric substrate.

10. The method of claim 9, wherein the polymeric substrate is in the form of a membrane.

11. The method of claim 9, wherein the polymeric substrate is in the form of discrete particles.

12. The method of claim 9, wherein the polymeric substrate is attached to a solid state support.

13. The method of any one of claims 9 to 12, wherein the polymeric substrate is selective for at least one of heptose and 2-keto-3-deoxyoctonic acid.

14. The method of claim 9, wherein the lipopolysaccharide is from Gram-negative bacteria.

15. The method of claim 14, wherein the Gram-negative bacteria are proteobacteria, cyanobacteria, spirochaetes, green sulphur bacteria, green non-sulphur bacteria, crenarchaeota or nosocomial bacteria.

16. The method of claim 9, wherein the suspension comprises water.

17. The method of claim 9, wherein the suspension comprises a pharmaceutical ingredient.

18. The method of claim 17, wherein the pharmaceutical ingredient is a bacterial vaccine.

19. The membrane of claim 1, wherein the polymeric substrate comprises one or more polar groups.

20. The membrane of claim 19, wherein the polymeric substrate comprises one or more hydroxyl groups.

21. The membrane of claim 1, wherein the polymeric substrate comprises poly(ethylene-co-vinyl alcohol).

22. The membrane of claim 21, wherein the ratio of ethylene:co-vinyl alcohol in the poly(ethylene-co-vinyl alcohol) is 30-60:70-40.

23. A polymeric substrate produced by the process of claim 5 or claim 6.

24. The process of claim 5 or claim 6, wherein the polymeric substrate comprises one or more polar groups.

25. The method of claim 9, wherein the polymeric substrate comprises one or more polar groups.

26. The process of claim 24, wherein the polymeric substrate comprises one or more hydroxyl groups.

27. The method claim 25, wherein the polymeric substrate comprises one or more hydroxyl groups.

28. The process of claim 5 or claim 6, wherein the polymeric substrate comprises poly(ethylene-co-vinyl alcohol).

29. The method of claim 25, wherein the polymeric substrate comprises poly(ethylene-co-vinyl alcohol).

30. The process of claim 28, wherein the ratio of ethylene:co-vinyl alcohol in the poly(ethylene-co-vinyl alcohol) is 30-60:70-40.

31. The method of claim 29, wherein the ratio of ethylene:co-vinyl alcohol in the poly(ethylene-co-vinyl alcohol) is 30-60:70-40.

32. A polymeric substrate produced by the process of claim 7.
